(19) United States
(12) Patent Application Publication
(10) Pub. No.: US 2026/0011283 A1
(43) Pub. Date: Jan. 8, 2026

(54) BRIGHTNESS COMPENSATION METHOD, DRIVING METHOD FOR DISPLAY PANEL AND DISPLAY DEVICE

(71) Applicant: Wuhan Tianma Microelectronics Co., Ltd., Wuhan (CN)

(72) Inventors: Hua XU, Wuhan (CN); Xigang LIU, Wuhan (CN)

(21) Appl. No.: 19/330,817

(22) Filed: Sep. 16, 2025

(30) Foreign Application Priority Data
Jun. 24, 2025 (CN) 202510855527.0

(51) Int. Cl. G09G 3/20

(52) U.S. Cl. CPC G09G 3/2092; G09G 2320/0276; G09G 2320/0673; G09G 2360/16

(57) ABSTRACT

Provided are a brightness compensation method, a driving method for a display panel and a display device. The brightness compensation method is configured to determine a brightness compensation function of the display panel. For a first Gamma value, the method includes: determining a first grayscale interval including at least three anchor grayscales and a plurality of non-anchor grayscales; acquiring an initial nonlinear function corresponding to the first grayscale interval, and correcting the nonlinear function corresponding to the first grayscale interval according to preset brightness information and theoretical brightness information corresponding to the anchor grayscales in the first grayscale interval. The brightness information corresponding to the non-anchor grayscale acquired according to the corrected nonlinear function is close to the ideal brightness information.

### CROSS-REFERENCE TO RELATED APPLICATION

The present disclosure claims priority to Chinese Patent Application No. 202510855527.0, filed on Jun. 24, 2025, the content of which is incorporated herein by reference in its entirety.

### TECHNICAL FIELD

The present disclosure relates to the field of display technologies, and in particular, to a brightness compensation method, a driving method for a display panel, and a display device.

### BACKGROUND

To adapt to different sensitivities of human eyes to bright and dark displays, a relationship between a plurality of grayscales that a display panel can display and their respective corresponding brightness is not a simple linear relationship. In fact, a corresponding relationship between grayscales and brightness satisfies a Gamma curve. A mapping relationship between grayscales and data voltages that characterizes brightness is stored in a register of a driving module. Therefore, before the driving module outputs data voltages to sub-pixels of the display panel to drive the sub-pixels to emit light, a data voltage corresponding to a grayscale that the pixel needs to display may be determined by looking up the mapping relationship in the register.

Due to a limited storage space of the register, only some grayscales and their corresponding data voltages are stored in the register. For example, the display panel can display grayscales from 0 to 255, but only the mapping relationship of grayscales from 16 to 24 and their corresponding data voltages are stored in the register. The grayscales stored in the register are referred to as anchor grayscales, and other grayscales except the anchor grayscales are referred to as non-anchor grayscales. In this case, when determining a data voltage corresponding to an anchor grayscale, the driving module may directly look the data voltage corresponding to the anchor grayscale up from the registers. When determining a data voltage corresponding to a non-anchor grayscale, the driving module may obtain the data voltage corresponding to the non-anchor grayscale through a linear interpolation algorithm based on two anchor grayscales adjacent to the non-anchor grayscale and their corresponding data voltages.

However, at least some of the non-anchor grayscales and their corresponding data voltages obtained through the linear interpolation algorithm obviously cannot match the Gamma curve, thereby affecting the display effect and the viewing experience of a user.

### SUMMARY

In view of this, embodiments of the present disclosure provide a brightness compensation method, a driving method for a display panel and a display device to solve the above problems.

In a first aspect, an embodiment of the present disclosure provides a brightness compensation method for determining a brightness compensation function of a display panel., The method includes: determining a first grayscale interval for a first Gamma value, where the first grayscale interval includes at least three anchor grayscales and a plurality of non-anchor grayscales; acquiring a first initial nonlinear function corresponding to the first grayscale interval based on the first grayscale interval; and correcting the first initial nonlinear function corresponding to the first grayscale interval according to preset brightness information and theoretical brightness information corresponding to the at least three anchor grayscales in the first grayscale interval, so that preset brightness information corresponding to a same anchor grayscale in the first grayscale interval matches theoretical brightness information, where theoretical brightness information is brightness information corresponding to an anchor grayscale obtained based on a nonlinear function.

In a second aspect, an embodiment of the present disclosure provides a driving method for a display panel, including: calling a first nonlinear function corresponding to a first grayscale interval based on a first non-anchor grayscale belonging to the first grayscale interval, where the first nonlinear function corresponding to the first grayscale interval is a corrected nonlinear function obtained by the method according to the first aspect; and acquiring a data voltage corresponding to the first non-anchor grayscale based on the first nonlinear function corresponding to the first grayscale interval.

In a third aspect, an embodiment of the present disclosure provides a chip configured to perform the driving method according to the second aspect.

In a fourth aspect, an embodiment of the present disclosure provides a display panel configured to be driven to display using the driving method according to the second aspect.

In a fifth aspect, an embodiment of the present disclosure provides a display device, including the display panel according to the fourth aspect.

In the embodiments of the present disclosure, the nonlinear function corresponding to the grayscale interval is corrected based on the preset brightness information and the theoretical brightness information of the at least three anchor grayscales in the grayscale interval. When the corrected nonlinear function makes the preset brightness information corresponding to the three anchor grayscales match the theoretical brightness information corresponding to the three anchor grayscales, respectively, the brightness information corresponding to the non-anchor grayscales in the grayscale interval acquired based on the corrected nonlinear function is also close to the ideal brightness information.

### BRIEF DESCRIPTION OF DRAWINGS

In order to more clearly illustrate the technical solutions in the embodiments of the present disclosure, the drawings, which are intended to be used in the description of the embodiments, are briefly described as below. It is apparent that the drawings described below are merely some embodiments of the present disclosure, and other drawings may be obtained by those skilled in the art according to these drawings without paying creative efforts.

FIG. 1 is a schematic flowchart of a brightness compensation method for a display panel according to an embodiment of the present disclosure;

FIG. 2 is a schematic flowchart of a brightness compensation method for a display panel according to an embodiment of the present disclosure;

FIG. 3 is a schematic flowchart of a brightness compensation method for a display panel according to an embodiment of the present disclosure;

FIG. 4 is a schematic flowchart of a brightness compensation method for a display panel according to an embodiment of the present disclosure;

FIG. 5 is a schematic flowchart of a brightness compensation method for a display panel according to an embodiment of the present disclosure;

FIG. 6 is a schematic diagram of determining a target interval according to an embodiment of the present disclosure;

FIG. 7 is a schematic flowchart of a brightness compensation method for a display panel according to an embodiment of the present disclosure;

FIG. 8 is a schematic diagram of a relationship between a preset brightness value/a theoretical brightness value and a grayscale value;

FIG. 9 is a schematic diagram of a difference between a preset brightness value and a theoretical brightness value;

FIG. 10 is a schematic flowchart of a brightness compensation method for a display panel according to an embodiment of the present disclosure;

FIG. 11 is a schematic flowchart of a brightness compensation method for a display panel according to an embodiment of the present disclosure;

FIG. 12 is a schematic flowchart of a brightness compensation method for a display panel according to an embodiment of the present disclosure;

FIG. 13 is a schematic flowchart of a brightness compensation method for a display panel according to an embodiment of the present disclosure;

FIG. 14 is a schematic flowchart of a driving method for a display panel according to an embodiment of the present disclosure;

FIG. 15 is a schematic flowchart of a driving method for a display panel according to an embodiment of the present disclosure;

FIG. 16 is a schematic flowchart of a driving method for a display panel according to an embodiment of the present disclosure;

FIG. 17 is a schematic flowchart of a driving method for a display panel according to an embodiment of the present disclosure;

FIG. 18 is a schematic diagram of a display panel according to an embodiment of the present disclosure; and

FIG. 19 is a schematic diagram of a display device according to an embodiment of the present disclosure.

### DESCRIPTION OF EMBODIMENTS

In order to better understand technical solutions of the present disclosure, embodiments of the present disclosure are described in detail below in conjunction with the drawings.

It should be made clear that the described embodiments are merely some but not all of the embodiments of the present disclosure. Based on the embodiments of the present disclosure, all other embodiments obtained by those ordinary skilled in the art without creative efforts shall fall within a protection scope of the present disclosure.

Terms used in the embodiments of the present disclosure are merely for the purpose of describing specific embodiments but not intended to limit the present disclosure. Terms “a/an” and “the/said” in a singular form in the embodiments of the present disclosure and the attached claims are also intended to include plural forms thereof, unless explicitly noted otherwise in the context.

It should be understood that the term “and/or” used herein is merely an association relationship describing an associated object, indicating that there may be three relationships, for example, A and/or B, and may indicate: only A, both A and B, and only B. In addition, a symbol “/” in the context generally indicates that the relation between the objects is an “or” relationship.

In the description of the present disclosure, it should be understood that terms such as “substantially”, “approximate to”, “approximately”, “about”, “roughly”, and “in general” described in the claims and embodiments of the present disclosure mean general agreement within a reasonable process operation range or tolerance range, rather than an exact value.

It should be understood that although the terms “first”, “second”, and the like may be used to describe grayscale intervals in the embodiments of the present disclosure, these should not be limited to these terms. These terms are merely used to distinguish grayscale intervals from each other. For example, without departing from the scope of the embodiments of the present disclosure, a first grayscale interval may also be referred to as a second grayscale interval, and similarly, the second grayscale interval may also be referred to as the first grayscale interval. Through careful and in-depth research, a solution is provided for solving the problems existing in the related art.

An embodiment of the present disclosure provides a brightness compensation method for determining a brightness compensation function of a display panel. The brightness compensation function at least includes a nonlinear function that can determine a data voltage corresponding to a non-anchor grayscale according to a grayscale value of the non-anchor grayscale. It should be noted that the data voltage corresponding to the non-anchor grayscale may be directly obtained by substituting the non-anchor grayscale into the brightness compensation function determined in the embodiments of the present disclosure. A compensation grayscale corresponding to the non-anchor grayscale may also be obtained by substituting the non-anchor grayscale into the brightness compensation function determined in the embodiments of the present disclosure, and a driving module may further obtain the corresponding data voltage according to the compensation grayscale.

It should be noted that the display panel may include a plurality of brightness modes. For example, the display panel may determine a brightness mode in response to a user's selection of the brightness modes, or the display panel may determine a brightness mode in response to a change in ambient brightness. When the brightness modes of the display panel are different, Gamma curves called by the driving module when determining the data voltage corresponding to the grayscale may also be different. That is, in different brightness modes, Gamma values corresponding to a mapping table of grayscales and data voltages that the driving module needs to look up when determining a data voltage according to a grayscale are different.

The brightness compensation method according to the present disclosure can determine brightness compensation functions respectively corresponding to at least some of the Gamma values. For example, the brightness compensation method according to the embodiments of the present disclosure can acquire brightness compensation functions respectively corresponding to each of the Gamma values, and can also determine the brightness compensation functions respectively corresponding to some of the Gamma values. The brightness compensation function determined in the embodiments of the present disclosure is burned into the driving module for driving the display panel to emit light, so that when the driving module drives the display panel to emit light for display, the data voltage corresponding to the non-anchor grayscale output by the driving module to the display panel may be determined by calling the above brightness compensation function.

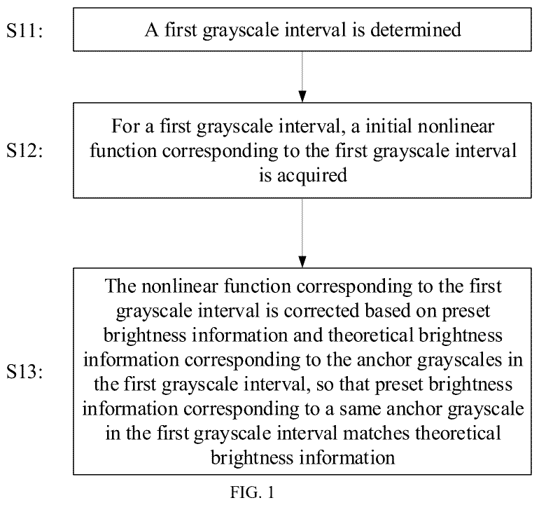

First, the embodiments of the present disclosure describe a method for determining a brightness compensation function of a display panel for a first Gamma value. FIG. 1 is a schematic flowchart of a brightness compensation method for a display panel according to an embodiment of the present disclosure. As shown in FIG. 1, the brightness compensation method according to the embodiments of the present disclosure includes steps of S11, S12, and S13:

S11, a first grayscale interval is determined.

The first grayscale interval is determined according to a grayscale range corresponding to the display panel. For example, if the grayscale range that the display panel can display ranges from 0 to 255, the first grayscale interval may be determined in the grayscale range from 0 to 255. It can be understood that multiple grayscales in the first grayscale interval are continuous grayscales in the above grayscale range. The first grayscale interval includes at least three anchor grayscales and a plurality of non-anchor grayscales. An anchor grayscale refers to a grayscale whose grayscale value is stored in a register and has a mapping relationship with a data voltage, and a non-anchor grayscale refers to other grayscales except the anchor grayscales.

For clear description, the first grayscale interval is taken as an example for description below, but the method for obtaining nonlinear functions corresponding to other grayscale intervals and brightness compensation functions including the nonlinear functions may also adopt the same inventive concept.

S12, for a first grayscale interval, an initial nonlinear function corresponding to the first grayscale interval is acquired.

The initial nonlinear function may be a pre-stored preset nonlinear function. In this case, acquiring the initial nonlinear function corresponding to the first grayscale interval may be calling the pre-stored preset nonlinear function.

The initial nonlinear function may also be an initial nonlinear function generated in response to a setting operation of a user. In this case, acquiring the initial nonlinear function corresponding to the first grayscale interval may be generating the initial nonlinear function in response to the setting operation of the user.

It should be further noted that initial nonlinear functions corresponding to different grayscale intervals may be different, and initial nonlinear functions corresponding to at least some of the grayscale intervals may also be the same.

S13, the nonlinear function corresponding to the first grayscale interval is corrected based on preset brightness information and theoretical brightness information corresponding to the anchor grayscales in the first grayscale interval, so that preset brightness information corresponding to a same anchor grayscale in the first grayscale interval matches theoretical brightness information.

It should be noted that the data voltage is positively or negatively correlated with the brightness of the sub-pixel receiving the data voltage. The brightness of the sub-pixel receiving the data voltage may be characterized by the data voltage regardless of whether the data voltage is positively correlated or negatively correlated, so that brightness information involved in the embodiments of the present disclosure may be the data voltage. Further, the data voltage may also be converted into a brightness value or a compensation grayscale value, so the brightness information may also be the brightness value or the compensation grayscale value. The nonlinear function involved in the embodiments of the present disclosure is a function representing a relationship between a grayscale and brightness information, that is, the nonlinear function may be a function representing a relationship between a grayscale and a data voltage, or may be a function representing a relationship between a grayscale and a brightness value or a compensation grayscale value. For ease of description, the following description takes the brightness information as a data voltage as an example, but the brightness information may also be a brightness value or a compensation grayscale value.

The preset brightness information is brightness information corresponding to an anchor grayscale determined according to a Gamma curve. The data voltage corresponding to the preset brightness information and a mapping relationship between the data voltage corresponding to the preset brightness information and the anchor grayscale may be stored in a register of the driving module.

The theoretical brightness information is brightness information corresponding to an anchor grayscale obtained based on the nonlinear function. When the brightness information is a data voltage, the theoretical brightness information is a data voltage corresponding to the anchor grayscale obtained according to the nonlinear function. When the brightness information is a brightness value, the theoretical brightness information is a brightness value that can be presented when the sub-pixel is driven to emit light by the data voltage corresponding to the anchor grayscale obtained according to the nonlinear function. When the brightness information is a compensation grayscale value, the theoretical brightness information is a compensation grayscale value corresponding to the anchor grayscale obtained according to the nonlinear function.

The nonlinear function corresponding to the first grayscale interval is corrected based on the preset brightness information and the theoretical brightness information corresponding to the anchor grayscale in the first grayscale interval. If the data voltage of the anchor grayscale is obtained according to the corrected nonlinear function, and the theoretical brightness information corresponding to the data voltage matches the preset brightness information of the anchor grayscale, the nonlinear function may be used as a target nonlinear function corresponding to the first grayscale interval, and the target nonlinear function is used as the nonlinear function corresponding to the first grayscale interval in the brightness compensation function. For example, if the data voltage of the anchor grayscale obtained according to the corrected nonlinear function matches the data voltage corresponding to the anchor grayscale pre-stored in the register, the nonlinear function is the target nonlinear function corresponding to the first grayscale interval. The matching of the preset brightness information and the theoretical brightness information means that the preset brightness information and the theoretical brightness information are the same or almost the same considering conventional losses.

In order to make the data voltage corresponding to the non-anchor grayscale obtained according to the nonlinear function closer to the ideal data voltage, in the embodiments of the present disclosure, the initial nonlinear function is corrected to obtain the target nonlinear function. Alternatively, after the initial nonlinear function is corrected once, if the requirement is still not met, the nonlinear function may be continuously corrected to obtain the target nonlinear function. The brightness value or the compensation grayscale value corresponding to the ideal data voltage of the non-anchor grayscale is the same as the brightness value or the compensation grayscale value corresponding to the non-anchor grayscale determined according to the Gamma curve corresponding to the first Gamma value.

Since the first grayscale interval includes at least three anchor grayscales, the preset brightness information and the theoretical brightness information based on which the nonlinear function corresponding to the first grayscale interval is corrected are the preset brightness information and the theoretical brightness information of the at least three anchor grayscales.

In some embodiments of the present disclosure, the nonlinear function corresponding to the grayscale interval is corrected based on the preset brightness information and the theoretical brightness information of the at least three anchor grayscales in the grayscale interval, and when the corrected nonlinear function makes the preset brightness information corresponding to the three anchor grayscales match the theoretical brightness information corresponding to the three anchor grayscales, respectively, the brightness information corresponding to the non-anchor grayscales in the grayscale interval acquired according to the corrected nonlinear function is also close to the ideal brightness information.

According to the above method, for the first Gamma value, a plurality of grayscale intervals may be determined and nonlinear functions respectively corresponding to the plurality of grayscale intervals may be obtained, and a combination of the nonlinear functions respectively corresponding to the plurality of grayscale intervals may be regarded as a piecewise function.

In an embodiment of the present disclosure, correcting the nonlinear function includes correcting an exponent and/or a multiplier of the nonlinear function, where both the exponent and the multiplier may be corrected, or only the exponent may be corrected, or only the multiplier may be corrected.

Correcting the nonlinear function corresponding to the first grayscale interval includes correcting the exponent and/or the multiplier of the nonlinear function corresponding to the first grayscale interval.

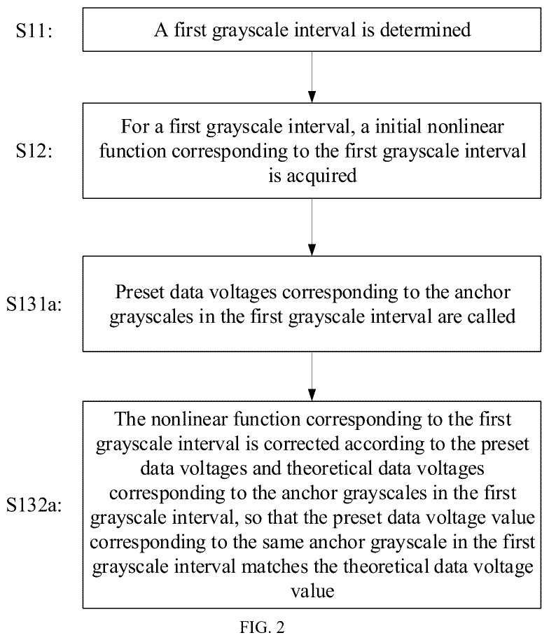

In an embodiment of the present disclosure, the preset brightness information is a preset data voltage value, and the theoretical brightness information is a theoretical data voltage value. FIG. 2 is a schematic flowchart of a brightness compensation method for a display panel according to an embodiment of the present disclosure. As shown in FIG. 2, in the brightness compensation method according to the embodiments of the present disclosure, the step S13, that is, the nonlinear function corresponding to the first grayscale interval is corrected according to preset luminance information and theoretical luminance information corresponding to the anchor grayscales in the first grayscale interval, so that the preset luminance information corresponding to the same anchor grayscale in the first grayscale interval matches the theoretical luminance information, includes steps of S131a and S132a.

S131a, preset data voltages corresponding to the anchor grayscales in the first grayscale interval are called.

The preset data voltage is a data voltage corresponding to the anchor grayscale determined according to the Gamma curve, and the preset data voltage may be pre-stored in the register of the driving module. When the grayscale value of the anchor grayscale is known, the preset data voltage corresponding to the grayscale value may be looked up from the register of the driving module.

S132a: the nonlinear function corresponding to the first grayscale interval is corrected according to the preset data voltages and theoretical data voltages corresponding to the anchor grayscales in the first grayscale interval, so that the preset data voltage value corresponding to the same anchor grayscale in the first grayscale interval matches the theoretical data voltage value.

That is, the anchor grayscale of the first grayscale interval is substituted into the initial nonlinear function to obtain a theoretical data voltage value, and the nonlinear function is continuously corrected by comparing the voltage value of the theoretical data voltage and the voltage value of the preset data voltage of the anchor grayscale until the difference between the voltage value of the theoretical data voltage of the anchor grayscale obtained through the linear function and the voltage value of the preset data voltage of the anchor grayscale meets the requirements.

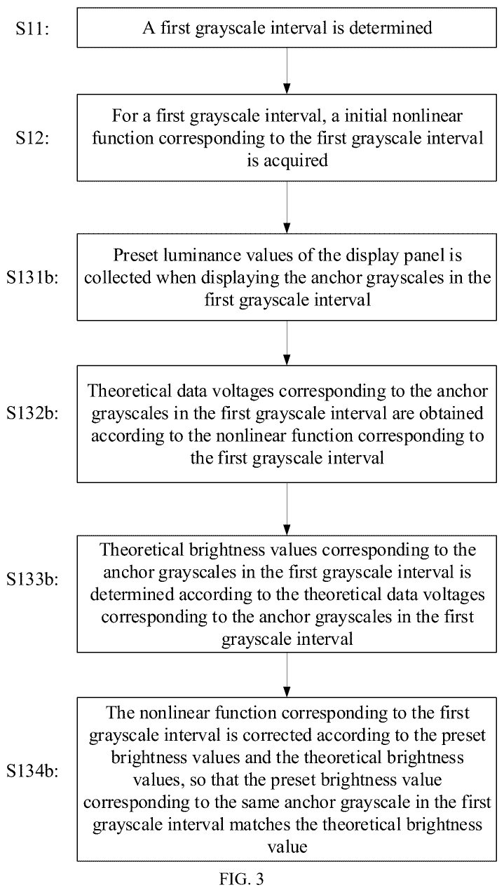

In an embodiment of the present disclosure, the preset brightness information is a preset brightness value/a preset compensation grayscale value, and the theoretical brightness information is a theoretical brightness value/a theoretical compensation grayscale value. FIG. 3 is a schematic flowchart of a brightness compensation method for a display panel according to an embodiment of the present disclosure. As shown in FIG. 3, in the brightness compensation method according to the embodiments of the present disclosure, the step S13, that is, the nonlinear function corresponding to the first grayscale interval is corrected according to preset brightness information and theoretical brightness information corresponding to the anchor grayscales in the first grayscale interval, so that the preset brightness information corresponding to the same anchor grayscale in the first grayscale interval matches the theoretical brightness information, includes steps of S131b, S132b, S133b, and S134b.

S131b, preset luminance values of the display panel is collected when displaying the anchor grayscales in the first grayscale interval.

The display panel may be controlled to display the anchor grayscale in the first grayscale interval, and at this time, the brightness of the display panel may be collected as the preset brightness value of the anchor grayscale. The preset brightness value may be further converted into a preset compensation grayscale value.

Alternatively, the preset brightness value or the preset compensation grayscale value corresponding to the anchor grayscale in the first grayscale interval may also be obtained according to the operation of the first Gamma value.

S132b, theoretical data voltages corresponding to the anchor grayscales in the first grayscale interval are obtained according to the nonlinear function corresponding to the first grayscale interval.

The anchor grayscale in the first grayscale interval is substituted into the corresponding initial nonlinear function to obtain a voltage value of the theoretical data voltage corresponding to the anchor grayscale.

S133b, theoretical brightness values corresponding to the anchor grayscales in the first grayscale interval is determined according to the theoretical data voltages corresponding to the anchor grayscales in the first grayscale interval.

The theoretical data voltage corresponding to the anchor grayscale obtained in the step S132b is converted into a brightness value or a compensation grayscale value, that is, a theoretical brightness value or a theoretical compensation grayscale value corresponding to the anchor grayscale in the first grayscale interval is obtained.

S134b, the nonlinear function corresponding to the first grayscale interval is corrected according to the preset brightness values and the theoretical brightness values, so that the preset brightness value corresponding to the same anchor grayscale in the first grayscale interval matches the theoretical brightness value.

By comparing the theoretical brightness value/theoretical compensation grayscale value and the preset brightness value/preset compensation grayscale value of the anchor grayscale, the nonlinear function is continuously corrected until the difference between the theoretical brightness value/theoretical compensation grayscale value of the anchor grayscale obtained through the linear function and the preset brightness value/preset compensation grayscale value of the anchor grayscale meets the requirements.

The theoretical brightness information is one of the main basis for determining whether to correct the nonlinear function and how to correct the nonlinear function. The embodiments of the present disclosure also provide a solution for acquiring the theoretical brightness information of the anchor grayscale.

Since the brightness value corresponding to each grayscale in the grayscale interval changes relatively smoothly with the change of the corresponding grayscale value, the data voltage corresponding to each grayscale in the grayscale interval also changes smoothly with the change of the grayscale value, so that the anchor grayscale and the non-anchor grayscale in the grayscale interval and the data voltage corresponding to the anchor grayscale and the non-anchor grayscale in the grayscale interval can satisfy the same nonlinear function. Therefore, one solution for acquiring the theoretical brightness information of the anchor grayscale includes: the anchor grayscale is substituted into the nonlinear function to calculate a data voltage corresponding to the anchor grayscale, and the data voltage may be used as the theoretical brightness information of the anchor grayscale or the data voltage may be converted into the theoretical brightness information. Further, by comparing the theoretical brightness information with the preset brightness information, it is determined whether the nonlinear function needs to be corrected and how the nonlinear function should be corrected. In this solution, the anchor grayscale is substituted into the nonlinear function corresponding to the grayscale interval of the anchor grayscale to determine the theoretical brightness information, which is simpler and has lower requirements on computing power.

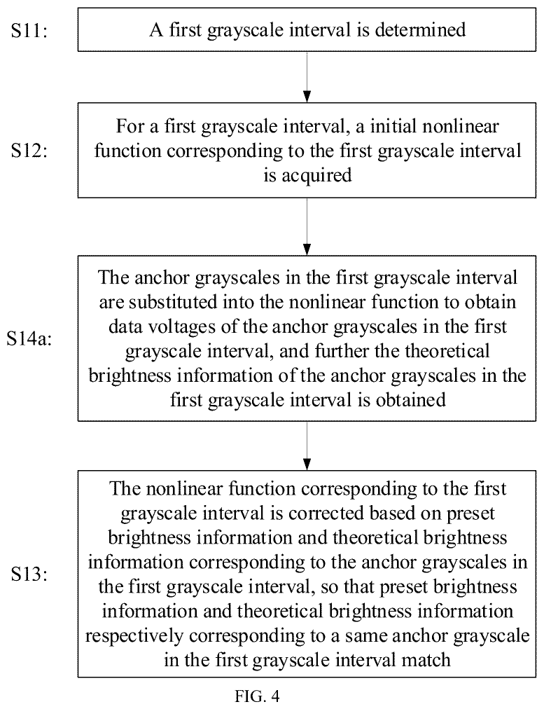

As shown in FIG. 4, which is a schematic flowchart of a brightness compensation method for a display panel according to an embodiment of the present disclosure, the method provided by the embodiments of the present disclosure further includes a step of S14a.

S14a, the anchor grayscales in the first grayscale interval are substituted into the nonlinear function to obtain data voltages of the anchor grayscales in the first grayscale interval, and further the theoretical brightness information of the anchor grayscales in the first grayscale interval is obtained.

It should be noted that, in the step S13, the nonlinear function needs to be corrected multiple times. The theoretical brightness information of the anchor grayscale on which the first correction is based may be determined by substituting the anchor grayscale into the initial nonlinear function. The theoretical brightness information of the anchor grayscale on which each subsequent correction is based may be determined by substituting the anchor grayscale into the nonlinear function obtained from the previous correction.

Since the target nonlinear function obtained in the embodiments of the present disclosure is used to determine the data voltage corresponding to the non-anchor grayscale, if the theoretical brightness information of the anchor grayscale is acquired based on the theoretical brightness information of the non-anchor grayscale, and the nonlinear function is corrected based on the theoretical brightness information of the anchor grayscale obtained in this way to obtain the target nonlinear function, the correlation between the data voltage corresponding to the anchor grayscale determined based on the target nonlinear function and the data voltage corresponding to the non-anchor grayscale is stronger. Therefore, one solution for obtaining the theoretical brightness information of the anchor grayscale includes: the theoretical brightness information of the anchor grayscale may be determined based on the theoretical brightness information of the non-anchor grayscale, where the theoretical brightness information of the non-anchor grayscale may be determined by substituting the non-anchor grayscale into the nonlinear function to calculate the data voltage corresponding to the non-anchor grayscale, and then data voltages of a plurality of non-anchor grayscales in the grayscale interval are integrated to calculate the theoretical brightness information of the anchor grayscale in the grayscale interval.

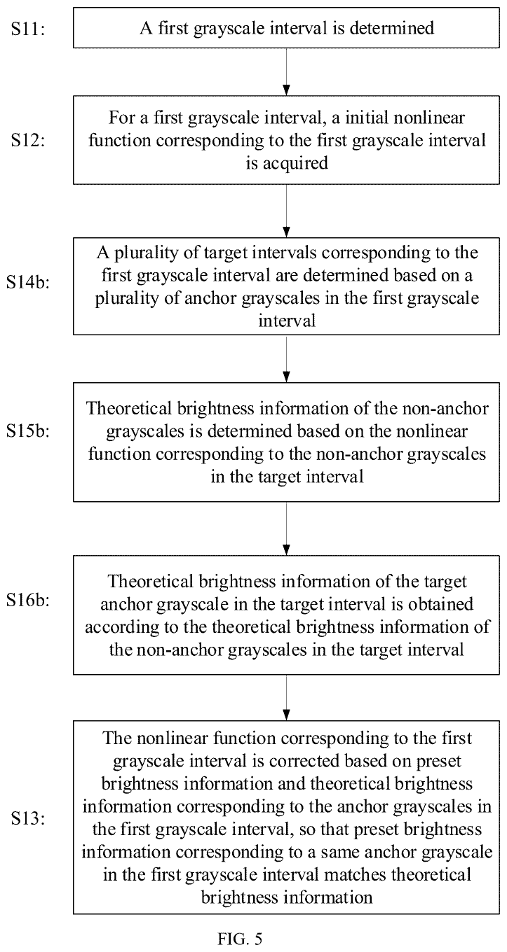

As shown in FIG. 5, which is a schematic flowchart of a brightness compensation method for a display panel according to an embodiment of the present disclosure, the method provided by the embodiments of the present disclosure further includes steps of S14b, S15b, and S16b.

S14b, a plurality of target intervals corresponding to the first grayscale interval are determined based on a plurality of anchor grayscales in the first grayscale interval.

Since the grayscale values of the anchor grayscales in the first grayscale interval and their corresponding theoretical brightness information are one of the main bases for correcting the nonlinear function corresponding to the first grayscale interval, the theoretical brightness information of each anchor grayscale in the first grayscale interval needs to be obtained. Therefore, each anchor grayscale in the first grayscale interval may be used as a target anchor grayscale, and the theoretical brightness information of each target anchor grayscale may be obtained. Therefore, in the embodiments of the present disclosure, a plurality of target intervals are divided according to the anchor grayscales in the first grayscale interval. The target interval includes at least three anchor grayscales and the target anchor grayscale in the target interval is an anchor grayscale in the first grayscale interval, and a grayscale value of the target anchor grayscale in the target interval is between grayscale values of other anchor grayscales in the target interval.

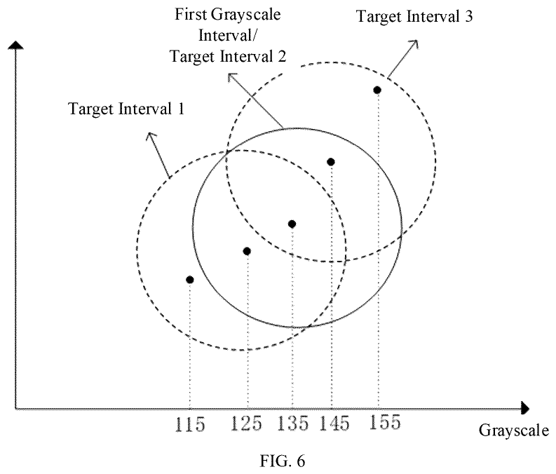

For example, as shown in FIG. 6, which is a schematic diagram of determining a target interval according to an embodiment of the present disclosure, the first grayscale interval includes three anchor grayscales with grayscale values of 125, 135, and 145, respectively. Then, the target interval 1 is divided with the 125 grayscale as the target anchor grayscale, and the target interval 1 includes three anchor grayscales with grayscale values of 115, 125, and 135. The target interval 2 is divided with the 135 grayscale as the target anchor grayscale, and the target interval 2 includes three anchor grayscales with grayscale values of 125, 135, and 145. The target interval 3 is divided with the 145 grayscale as the target anchor grayscale, and the target interval 3 includes three anchor grayscales with grayscale values of 135, 145, and 155.

In one implementation, the number of target intervals corresponding to the first grayscale interval is equal to the number of anchor grayscales in the first grayscale interval, that is, the number of target intervals corresponding to the first grayscale interval is the same as the number of anchor grayscales in the first grayscale interval, and the target interval also includes grayscales with continuous grayscale values. For example, as shown in FIG. 6, the first grayscale interval includes three anchor grayscales, and three target intervals corresponding to the first grayscale interval are divided.

In one implementation, the target anchor grayscale is an intermediate value among grayscale values of the plurality of anchor grayscales in the target interval where the target anchor grayscale is located. For example, each target interval in FIG. 6 includes three anchor grayscales, and the anchor grayscale with the intermediate grayscale value among the three anchor grayscales is the target anchor grayscale.

S15b, theoretical brightness information of the non-anchor grayscales is determined based on the nonlinear function corresponding to the non-anchor grayscales in the target interval.

That is, the non-anchor grayscales in the target interval are respectively substituted into the nonlinear function corresponding to the non-anchor grayscales to obtain data voltages respectively corresponding to the non-anchor grayscales. The data voltages corresponding to the non-anchor grayscales may be used as the theoretical brightness information of the non-anchor grayscales, or the data voltages corresponding to the non-anchor grayscales may be converted into brightness values or compensation grayscale values as the theoretical brightness information of the non-anchor grayscales.

It should be noted that the nonlinear function corresponding to the non-anchor grayscales is the same as the nonlinear function corresponding to the grayscale interval of the non-anchor grayscales. The nonlinear functions corresponding to the non-anchor grayscales in the same target interval may be the same or different. If all non-anchor grayscales in the target interval belong to the same grayscale interval, nonlinear functions corresponding to the non-anchor grayscales are the same. If a part of the non-anchor grayscales in the target interval belong to one grayscale interval and another part of the non-anchor grayscales belong to another grayscale interval, when the nonlinear functions corresponding to these two grayscale intervals are different, nonlinear functions corresponding to a part of the non-anchor grayscales are different from nonlinear functions corresponding to another part of the non-anchor grayscales. For example, as shown in FIG. 6, if the target interval 2 coincides with the first grayscale interval, the non-anchor grayscales in the target interval 2 all correspond to the same nonlinear function. For example, as shown in FIG. 6, if a part of the non-anchor grayscales in the target interval 2 belongs to the second grayscale interval and another part of the non-anchor grayscales in the target interval 2 belong to the first grayscale interval, the nonlinear function corresponding to the non-anchor grayscales in the target interval 2 belonging to the second grayscale interval is the nonlinear function corresponding to the second grayscale interval. The nonlinear function corresponding to the non-anchor grayscales in the target interval 2 belonging to the first grayscale interval is the nonlinear function corresponding to the first grayscale interval.

S16b, theoretical brightness information of the target anchor grayscale in the target interval is obtained according to the theoretical brightness information of the non-anchor grayscales in the target interval.

The target anchor grayscale is an anchor grayscale in the target interval, and the theoretical brightness information of the anchor grayscale in the target interval may be determined based on the theoretical brightness information of the non-anchor grayscales in the target interval. For example, if the theoretical brightness information is a theoretical data voltage, the theoretical data voltage of the target anchor grayscale in the target interval may be obtained by integrating theoretical data voltages respectively corresponding to the non-anchor grayscales in the target interval. For each target interval, the theoretical brightness information of each anchor grayscale in the first grayscale interval may be obtained according to the step S15b and the step S16b.

It should be noted that, in the step S13, the nonlinear function needs to be corrected multiple times. The theoretical brightness information of the anchor grayscale on which the first correction is based may be obtained by substituting the non-anchor grayscales into the initial nonlinear function to obtain the data voltages of the non-anchor grayscales and determining based on the data voltages of the non-anchor grayscales. The theoretical brightness information of the anchor grayscale on which each subsequent correction is based may be obtained by substituting the non-anchor grayscale into the nonlinear function after the previous correction to obtain the data voltage of the non-anchor grayscale and determining based on the data voltage of the non-anchor grayscale.

The theoretical brightness information of the non-anchor grayscale whose grayscale value is closer to that of the target anchor grayscale has a greater correlation with the theoretical brightness information of the target anchor grayscale, and the theoretical brightness information of the non-anchor grayscale whose grayscale value has a greater difference from that of the target anchor grayscale has a smaller correlation with the theoretical brightness information of the target anchor grayscale. Therefore, when the theoretical brightness information of the plurality of non-anchor grayscales is integrated to obtain the theoretical brightness information of the target anchor grayscale, a difference between the grayscale value of the non-anchor grayscale and the grayscale value of the target anchor grayscale should be considered.

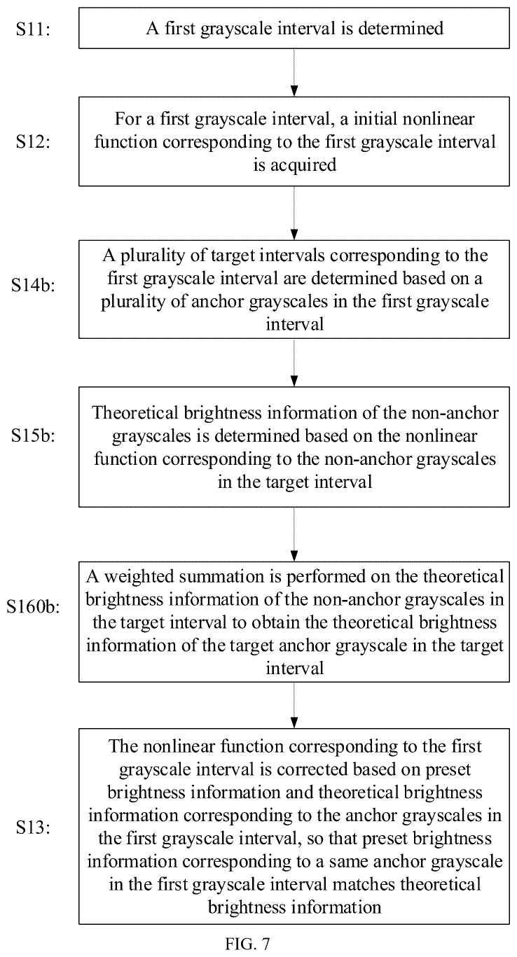

As shown in FIG. 7, which is a schematic flowchart of a brightness compensation method for a display panel according to an embodiment of the present disclosure, the step S16b, that is, theoretical brightness information of the target anchor grayscale in the target interval is obtained according to the theoretical brightness information of the non-anchor grayscales in the target interval, includes a step of S160.

S160b, a weighted summation is performed on the theoretical brightness information of the non-anchor grayscales in the target interval to obtain the theoretical brightness information of the target anchor grayscale in the target interval.

A weight for weighting the theoretical brightness information corresponding to the non-anchor grayscale is related to a difference between the grayscale value of the non-anchor grayscale and the grayscale value of the target anchor grayscale. Further, when a weighted summation is performed on the theoretical brightness information of the non-anchor grayscales in the target interval to obtain the theoretical brightness information of the target anchor grayscale, among the non-anchor grayscales, the theoretical brightness information of the non-anchor grayscale having a smaller absolute value of the difference from the grayscale value of the target anchor grayscale has a larger weight, and the theoretical brightness information of the non-anchor grayscale having a larger absolute value of the difference from the grayscale value of the target anchor grayscale has a smaller weight.

Taking the theoretical data voltage of the target anchor grayscale in the target interval 2 as an example for description, assuming that the nonlinear function corresponding to the target interval 2 is f(x), an independent variable of f(x) is the grayscale value of the non-anchor grayscale in the target interval 2, and a dependent variable is the data voltage (that is, the theoretical brightness information), and assuming that the weight for weighting the data voltage of the non-anchor grayscale is ω(s), then the theoretical data voltage F(x) of the target anchor grayscale in the target interval 2 is calculated by F(x)=Σf(x)*ω(s).

In an embodiment of the present disclosure, the weight o(s) for weighting the theoretical brightness information corresponding to the non-anchor grayscale satisfies:

$$ω ( s ) \{ \begin{matrix}\begin{matrix}4 {s}^{3} - 4 {s}^{2} + \frac{2}{3} , & 0 \leq s \leq 0.5\end{matrix} \\ \begin{matrix}\frac{4}{3} {( 1 - s )}^{3} , & 0.5 < s \leq 1\end{matrix} \\ \begin{matrix}0 , & s > 1\end{matrix}\end{matrix} ,$$

where s=d/D, D is a difference between an upper boundary and a lower boundary of the target interval, and d is an absolute value of the difference between the grayscale value of the non-anchor grayscale in the target interval and the grayscale value of the target anchor grayscale. Taking the target interval 2 shown in FIG. 6 as an example, assuming that the upper boundary of the target interval 2 is 150 and the lower boundary of the target interval 2 is 120, then D=30. Assuming that the weight ω for weighting the theoretical brightness information corresponding to the non-anchor grayscale 130 is solved, since the grayscale value of the target anchor grayscale in the target interval 2 is 135, then d=5. Therefore, the weight ω for weighting the theoretical brightness information corresponding to the non-anchor grayscale 130 is ω(⅙).

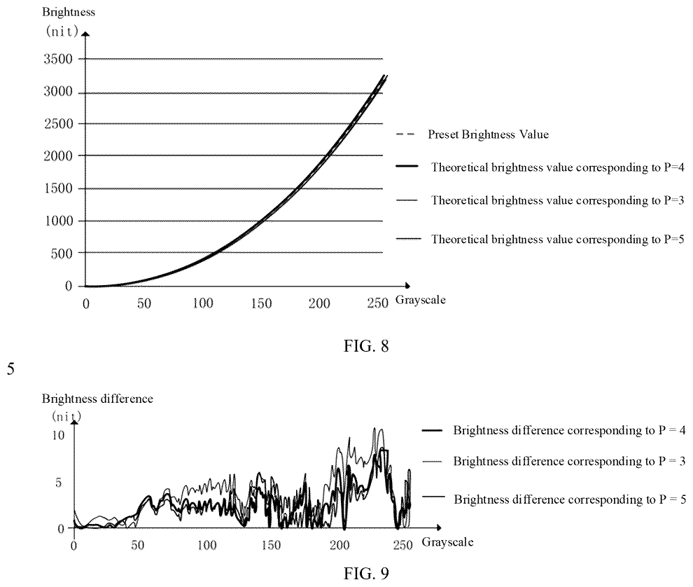

FIG. 8 is a schematic diagram of a relationship between a preset brightness value/a theoretical brightness value and a grayscale value. FIG. 9 is a schematic diagram of a distribution of a difference between a preset brightness value and a theoretical brightness value.

As shown in FIG. 8, the nonlinear function determined by the brightness compensation method provided in the embodiments of the present disclosure can make curves of the theoretical brightness value and the preset brightness value of the non-anchor grayscale with the change of grayscale values substantially coincide, and the smoothness of theoretical brightness values of non-anchor grayscales with the change of grayscale values is substantially the same as the smoothness of preset brightness values with the change of grayscale values. Although FIG. 8 shows that the brightness values obtained according to the nonlinear functions with the highest orders P of 3, 4, and 5 are relatively smooth with the change of grayscale values and fit preset brightness values with the change of grayscale values. However, it can still be seen from FIG. 9 that there are some differences in brightness differences between the theoretical brightness values obtained according to the nonlinear functions with the highest orders P of 3, 4, and 5 and their preset brightness values. For example, in FIG. 9, the overall brightness difference between the theoretical brightness value obtained according to the nonlinear function with the highest order P of 4 and the preset brightness value is smaller. Therefore, in the embodiments of the present disclosure, the nonlinear function is further corrected based on the theoretical brightness value obtained by the nonlinear function and the preset brightness value, so as to obtain a more ideal target nonlinear function after correction.

In an embodiment of the present disclosure, the data voltages corresponding to each non-anchor grayscale in the first grayscale interval may be obtained through the target nonlinear function corresponding to the first grayscale interval, so that the target nonlinear function of the first grayscale interval determined in the embodiments of the present disclosure is a part corresponding to the first grayscale interval in the brightness compensation function. When subsequently determining the data voltages corresponding to each non-anchor grayscale in the first grayscale interval according to the brightness compensation function, the target nonlinear function corresponding to the first grayscale interval is called, which is simple and has low requirements on computing power.

Therefore, all non-anchor grayscales in the first grayscale interval may be regarded as first-type non-anchor grayscales, and the first-type non-anchor grayscales and the corresponding theoretical brightness information satisfy the target nonlinear function.

In an embodiment of the present disclosure, among the grayscales in the first grayscale interval, the data voltage corresponding to the non-anchor grayscale whose grayscale value is close to the grayscale value of the anchor grayscale may be obtained through a linear interpolation algorithm, and the data voltage corresponding to the non-anchor grayscale whose grayscale value is relatively different from the grayscale value of the anchor grayscale may be obtained through the target nonlinear function corresponding to the first grayscale interval. Further, when the data voltages corresponding to the non-anchor grayscales in the first grayscale interval are subsequently determined according to the brightness compensation function, the data voltage corresponding to the non-anchor grayscale whose grayscale value is similar to the grayscale value of the anchor grayscale may be obtained by performing an interpolation algorithm based on the anchor grayscales and the corresponding data voltages, and the data voltage corresponding to the non-anchor grayscale whose grayscale value is relatively different from the anchor grayscale may be obtained by calling the target nonlinear function corresponding to the first grayscale interval.

Therefore, the first grayscale interval includes a first-type non-anchor grayscale and a second-type non-anchor grayscale, the second-type non-anchor grayscale is between the first-type non-anchor grayscale and the anchor grayscale, and an absolute value of a difference between a grayscale value of the first-type non-anchor grayscale in the first grayscale interval and a grayscale value of the anchor grayscale is greater than that of the second-type non-anchor grayscale in the second grayscale interval. The nonlinear function is a function for determining the brightness information corresponding to the first-type non-anchor grayscale according to the first-type non-anchor grayscale, that is, an independent variable of the corrected target nonlinear function corresponding to the first grayscale interval in the present disclosure is the first-type non-anchor grayscale in the first grayscale interval.

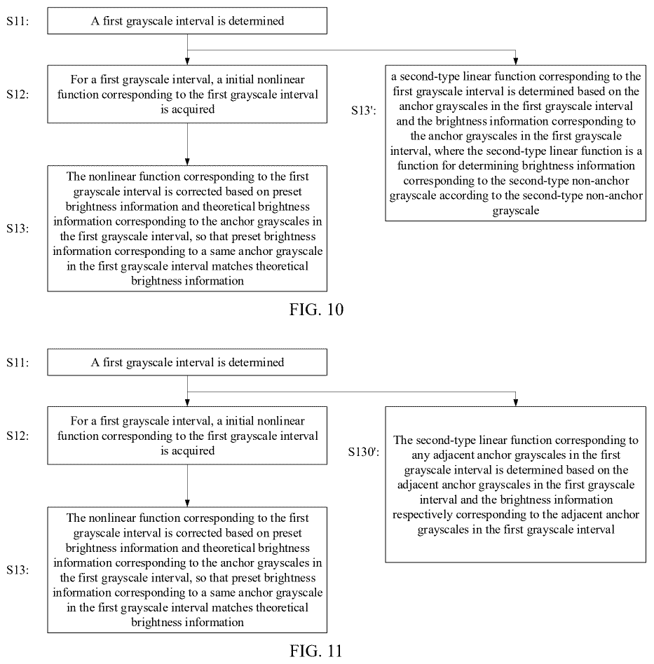

FIG. 10 is a schematic flowchart of a brightness compensation method for a display panel according to an embodiment of the present disclosure. As shown in FIG. 10, the brightness compensation method provided in an embodiment of the present disclosure further includes a step of S13′.

S13′, a second-type linear function corresponding to the first grayscale interval is determined based on the anchor grayscales in the first grayscale interval and the brightness information corresponding to the anchor grayscales in the first grayscale interval, where the second-type linear function is a function for determining brightness information corresponding to the second-type non-anchor grayscale according to the second-type non-anchor grayscale.

The second-type linear function may be a linear function corresponding to the interpolation algorithm used when calculating the brightness information corresponding to the second-type non-anchor grayscale.

FIG. 11 is a schematic flowchart of a brightness compensation method for a display panel according to an embodiment of the present disclosure. As shown in FIG. 11, the step S13′, that is, a second-type linear function corresponding to the first grayscale interval is determined based on the anchor grayscales in the first grayscale interval and the brightness information corresponding to the anchor grayscales in the first grayscale interval, includes a step of S130′.

S130′, the second-type linear function corresponding to any adjacent anchor grayscales in the first grayscale interval is determined based on the adjacent anchor grayscales in the first grayscale interval and the brightness information respectively corresponding to the adjacent anchor grayscales in the first grayscale interval.

The second-type linear function may be obtained according to two anchor grayscales with adjacent grayscale values in the first grayscale interval and the corresponding data voltages, and the data voltage corresponding to the second-type non-anchor grayscale whose grayscale value is between grayscale values of the two anchor grayscales may be determined through the second-type linear function.

According to the embodiments of the present disclosure, the brightness compensation function for determining the corresponding data voltage according to the non- anchor grayscale is obtained, and the brightness compensation function at least includes a target nonlinear function. The brightness when the sub-pixel is driven to emit light by the data voltage determined according to the target nonlinear function is almost the same as the ideal brightness corresponding to the non-anchor grayscale. To achieve the above purpose, different target nonlinear functions may be determined for different grayscale intervals, so that the data voltages corresponding to the non-anchor grayscales in each grayscale interval determined based on each target nonlinear function are more ideal.

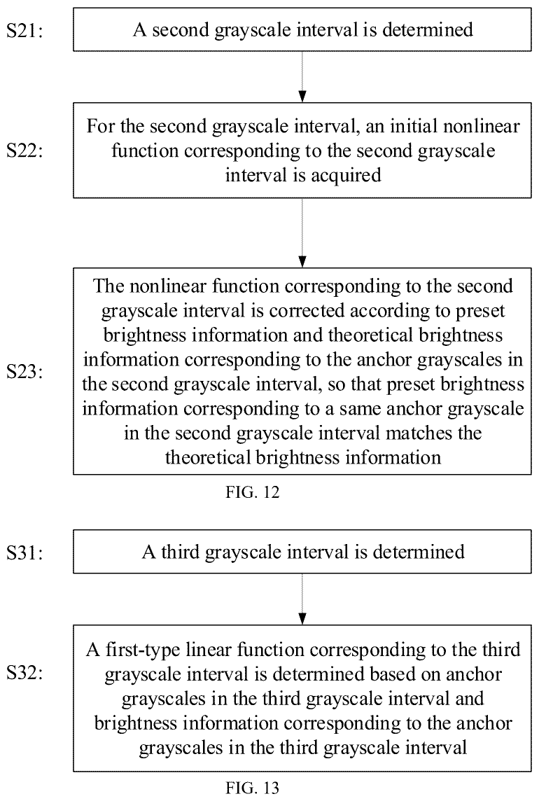

FIG. 12 is a schematic flowchart of a brightness compensation method for a display panel according to an embodiment of the present disclosure. As shown in FIG. 12, for a first gamma value, the brightness compensation method according to an embodiment of the present disclosure further includes steps of S21, S22, and S23.

S21, a second grayscale interval is determined.

The second grayscale interval is determined according to a grayscale range corresponding to the display panel. The second grayscale interval includes at least three anchor grayscales and a plurality of non-anchor grayscales. The plurality of grayscales in the second grayscale interval are continuous grayscales in the above grayscale range.

The second grayscale interval is different from the first grayscale interval, that is, the plurality of grayscales in the first grayscale interval are different from the plurality of grayscales in the second grayscale interval.

S22, for the second grayscale interval, an initial nonlinear function corresponding to the second grayscale interval is acquired.

The initial nonlinear function corresponding to the second grayscale interval may be the same as or different from the initial nonlinear function corresponding to the first grayscale interval.

S23, the nonlinear function corresponding to the second grayscale interval is corrected according to preset brightness information and theoretical brightness information corresponding to the anchor grayscales in the second grayscale interval, so that preset brightness information corresponding to a same anchor grayscale in the second grayscale interval matches the theoretical brightness information.

The nonlinear function corresponding to the second grayscale interval is corrected based on the preset brightness information and the theoretical brightness information corresponding to the anchor grayscale in the second grayscale interval. Since the second grayscale interval includes at least three anchor grayscales, the preset brightness information and the theoretical brightness information based on which the nonlinear function corresponding to the second grayscale interval is corrected are the preset brightness information and the theoretical brightness information of the at least three anchor grayscales.

A method for correcting the nonlinear function corresponding to the second grayscale interval to obtain the target nonlinear function corresponding to the second grayscale interval is the same as a specific method for correcting the nonlinear function corresponding to the first grayscale interval to obtain the target nonlinear function corresponding to the first grayscale interval, which will not be repeated herein.

The purpose of correcting the nonlinear function corresponding to each grayscale interval is to obtain a target nonlinear function, through which a relatively ideal data voltage corresponding to the non-anchor grayscale can be obtained. Since the nonlinear function corresponding to one grayscale interval is corrected mainly based on the preset brightness information and the theoretical brightness information of the anchor grayscale in the grayscale interval, the target nonlinear functions corresponding to at least some of the grayscale intervals may be different. Therefore, methods for correcting the nonlinear functions corresponding to different grayscale intervals may be different, to obtain more ideal target linear functions corresponding to each grayscale interval.

When both the nonlinear function corresponding to the first grayscale interval and the nonlinear function corresponding to the second grayscale interval are corrected, a correction method for the nonlinear function corresponding to the first grayscale interval may be the same as or different from a correction method for the nonlinear function corresponding to the second grayscale interval. For example, when correcting the nonlinear function corresponding to the first grayscale interval, both the exponent and the multiplier thereof may be corrected. When correcting the nonlinear function corresponding to the second grayscale interval, only the multiplier thereof may be corrected.

It should be noted that the brightness compensation method according to the embodiments of the present disclosure may obtain brightness compensation functions corresponding to each grayscale interval. It should be noted that the method for acquiring the brightness compensation function corresponding to the first grayscale interval is described in detail in the present disclosure. The method for obtaining the brightness compensation function including the nonlinear function corresponding to the second grayscale interval and other grayscale intervals can refer to the method for acquiring the brightness compensation function corresponding to the first grayscale interval, which will not be repeated herein.

When a change rate of the Gamma curve corresponding to the first Gamma value in some grayscale intervals is smaller, the difference between the brightness information corresponding to the non-anchor grayscale in the grayscale interval calculated using the linear interpolation algorithm and ideal brightness information corresponding to the non-anchor grayscale is smaller, thereby reducing the computing power and the storage space.

Therefore, as shown in FIG. 13, which is a schematic flowchart of a brightness compensation method for a display panel according to an embodiment of the present disclosure, the brightness compensation method according to an embodiment of the present disclosure further includes steps of S31, and S32.

S31, a third grayscale interval is determined.

A Gamma curve corresponding to the first Gamma value includes a first portion within the first grayscale interval and a second portion within the third grayscale interval, and a slope change rate of the first portion is greater than a slope change rate of the second portion.

S32, a first-type linear function corresponding to the third grayscale interval is determined based on anchor grayscales in the third grayscale interval and brightness information corresponding to the anchor grayscales in the third grayscale interval.

The first-type linear function is a function for determining the brightness information corresponding to the non-anchor grayscale according to the non-anchor grayscale in the third grayscale interval. That is, the brightness information corresponding to the non-anchor grayscales in the third grayscale interval may be obtained using a linear interpolation algorithm subsequently.

The display panel usually includes a plurality of brightness modes. Correspondingly, when the display panel displays in different brightness modes, the driving module of the display panel needs to call different Gamma curves. The above provides a brightness compensation method for the first Gamma value. For a second Gamma value, the brightness compensation method according to an embodiment of the present disclosure further includes steps of S41, S42, and S43.

S41, a first grayscale interval is determined.

The first grayscale interval includes at least three anchor grayscales and a plurality of non-anchor grayscale. The first grayscale interval determined for the second Gamma value may be the same as or different from the first grayscale interval determined for the first Gamma value.

S42, for the first grayscale interval, an initial nonlinear function corresponding to the first grayscale interval is acquired.

The initial nonlinear function acquired for the second Gamma value may be the same as or different from the initial nonlinear function acquired for the first Gamma value.

S43, the nonlinear function corresponding to the first grayscale interval is corrected according to preset brightness information and theoretical brightness information corresponding to the anchor grayscales in the first grayscale interval, so that preset brightness information corresponding to the same anchor grayscale in the first grayscale interval matches the theoretical brightness information.

The inventive concept for acquiring the brightness compensation function corresponding to the second Gamma value is the same as the inventive concept for acquiring the brightness compensation function corresponding to the first Gamma value, which will not be repeated herein.

It should be noted that the present disclosure not only provides embodiments related to basic technical solutions, but also provides embodiments related to multiple technical solutions extended based on the basic technical solutions. On the premise that these technical solutions do not conflict, the technical solutions obtained by combining them do not exceed the protection scope of the present disclosure.

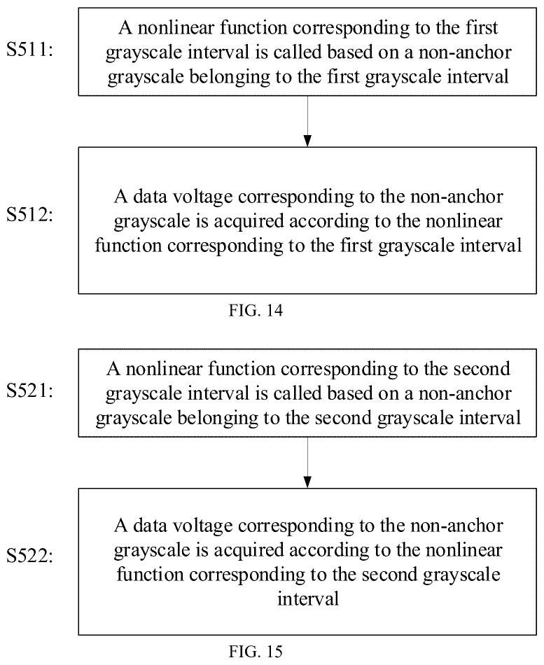

FIG. 14 is a schematic flowchart of a driving method for a display panel according to an embodiment of the present disclosure. An embodiment of the present disclosure further provides a driving method for a display panel for driving the display panel to emit light for display. As shown in FIG. 14, a driving method for a display panel according to an embodiment of the present disclosure includes steps of S511, and S512.

S511, a nonlinear function corresponding to the first grayscale interval is called based on a non-anchor grayscale belonging to the first grayscale interval.

Nonlinear functions corresponding to a plurality of grayscale intervals may be stored in a register of the driving module. When acquiring data voltages corresponding to at least some of the non-anchor grayscales belonging to different grayscale intervals, different nonlinear functions need to be called. The nonlinear function determined in the driving method and relied upon thereafter is the corrected nonlinear function obtained based on the above embodiments, that is, the target nonlinear function corresponding to the corresponding grayscale interval obtained based on the above embodiments.

When a non-anchor grayscale belongs to the first grayscale interval and the data voltage corresponding to the non-anchor grayscale needs to be acquired according to the nonlinear function, the nonlinear function corresponding to the first grayscale interval should be determined first, so as to call the nonlinear function. The nonlinear function corresponding to the first grayscale interval is the corrected nonlinear function obtained in the above embodiments, that is, the target nonlinear function corresponding to the first grayscale interval obtained based on the above embodiments.

S512, a data voltage corresponding to the non-anchor grayscale is acquired according to the nonlinear function corresponding to the first grayscale interval.

The non-anchor grayscale in the first grayscale interval is substituted into the corrected nonlinear function corresponding to the first grayscale interval, to acquire brightness information corresponding to the non-anchor grayscale, where the brightness information may be a data voltage, or the brightness information may also be a brightness value or a compensation grayscale value. If the brightness information is the brightness value or the compensation grayscale value, the brightness value is further converted into a data voltage.

In an embodiment of the present disclosure, as shown in FIG. 15, which is a schematic flowchart of a driving method for a display panel according to an embodiment of the present disclosure, the driving method for the display panel according to an embodiment of the present disclosure may further include steps of S521, and S522.

S521, a nonlinear function corresponding to the second grayscale interval is called based on a non-anchor grayscale belonging to the second grayscale interval.

The nonlinear function corresponding to the second grayscale interval is the corrected nonlinear function obtained based on the above embodiments, that is, the target nonlinear function corresponding to the second grayscale interval obtained based on the above embodiments. The second grayscale interval is different from the first grayscale interval.

When the non-anchor grayscale belongs to the second grayscale interval and the data voltage corresponding to the non-anchor grayscale needs to be acquired according to the nonlinear function, the nonlinear function corresponding to the second grayscale interval should be determined first, so as to call the nonlinear function.

S522, a data voltage corresponding to the non-anchor grayscale is acquired according to the nonlinear function corresponding to the second grayscale interval.

The non-anchor grayscale in the second grayscale interval is substituted into the corrected nonlinear function corresponding to the second grayscale interval, to acquire brightness information corresponding to the non-anchor grayscale, where the brightness information may be a data voltage, or the brightness information may also be a brightness value or a compensation grayscale value. If the brightness information is the brightness value or the compensation grayscale value, the brightness value is further converted into a data voltage.

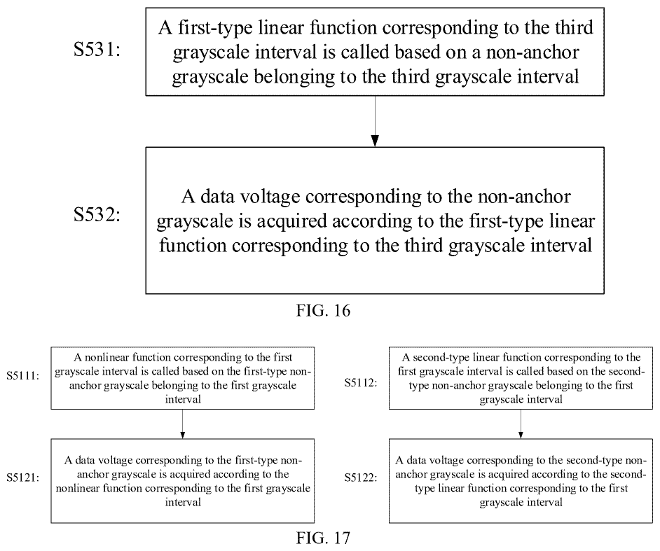

In an embodiment of the present disclosure, as shown in FIG. 16, which is a schematic flowchart of a driving method for a display panel according to an embodiment of the present disclosure, the driving method for the display panel according to an embodiment of the present disclosure may further include steps of S531, and S532.

S531, a first-type linear function corresponding to the third grayscale interval is called based on a non-anchor grayscale belonging to the third grayscale interval.

The first-type linear function corresponding to the third grayscale interval is the first-type linear function obtained based on the above embodiments, that is, the first-type linear function corresponding to the third grayscale interval obtained based on the above embodiments. The third grayscale interval is different from the first grayscale interval and the second grayscale interval.

When the non-anchor grayscale belongs to the third grayscale interval and the data voltage corresponding to the non-anchor grayscale needs to be acquired according to the first-type linear function, the first-type linear function corresponding to the third grayscale interval should be determined first, so as to call the linear function.

S532, a data voltage corresponding to the non-anchor grayscale is acquired according to the first-type linear function corresponding to the third grayscale interval.

The non-anchor grayscale in the third grayscale interval is substituted into the first-type nonlinear function corresponding to the third grayscale interval, to acquire brightness information corresponding to the non-anchor grayscale, where the brightness information may be a data voltage, or the brightness information may also be a brightness value or a compensation grayscale value. If the brightness information is the brightness value or the compensation grayscale value, the brightness value is further converted into a data voltage.

In an embodiment of the present disclosure, the first grayscale interval includes a first-type non-anchor grayscale and a second-type non-anchor grayscale, and the second-type non-anchor grayscale is between the first-type non-anchor grayscale and the anchor grayscale. As shown in FIG. 17, FIG. 17 is a schematic flowchart of a driving method for a display panel according to an embodiment of the present disclosure, the step S511, that is, a nonlinear function corresponding to the first grayscale interval is called based on a non-anchor grayscale belonging to the first grayscale interval, includes steps of S5111, and S5112; and the step S512, that is, a data voltage corresponding to the non-anchor grayscale is acquired according to the nonlinear function corresponding to the first grayscale interval, includes steps of S5121 and S5122.

S5111, a nonlinear function corresponding to the first grayscale interval is called based on the first-type non-anchor grayscale belonging to the first grayscale interval.

S5112, a second-type linear function corresponding to the first grayscale interval is called based on the second-type non-anchor grayscale belonging to the first grayscale interval.

S5121, a data voltage corresponding to the first-type non-anchor grayscale is acquired according to the nonlinear function corresponding to the first grayscale interval.

S5122, a data voltage corresponding to the second-type non-anchor grayscale is acquired according to the second-type linear function corresponding to the first grayscale interval.

The first-type linear function corresponding to the first grayscale interval is the nonlinear function obtained based on the above embodiments, that is, the target nonlinear function corresponding to the first grayscale interval obtained based on the above embodiments. The second-type linear function corresponding to the first grayscale interval is the linear function obtained based on the above embodiments, that is, the second linear function corresponding to the first grayscale interval obtained based on the above embodiments. When the non-anchor grayscale is the first-type non-anchor grayscale in the first grayscale interval and the data voltage corresponding to the non-anchor grayscale needs to be acquired according to the nonlinear function, the nonlinear function corresponding to the first grayscale interval should be determined first, so as to call the nonlinear function. When the non-anchor grayscale is the second-type non-anchor grayscale in the first grayscale interval and the data voltage corresponding to the non-anchor grayscale needs to be acquired according to the second-type linear function, the second-type linear function corresponding to the first grayscale interval should be determined first, so as to call the linear function.

The first-type non-anchor grayscale in the first grayscale interval is substituted into the target nonlinear function corresponding to the first grayscale interval, to obtain brightness information corresponding to the non-anchor grayscale, where the brightness information may be a data voltage, or the brightness information may also be a brightness value or a compensation grayscale value. If the brightness information is the brightness value or the compensation grayscale value, the brightness value is further converted into a data voltage. The second-type non-anchor grayscale in the first grayscale interval is substituted into the second-type function corresponding to the first grayscale interval, to acquire brightness information corresponding to the non-anchor grayscale, where the brightness information may be a data voltage, or the brightness information may also be a brightness value or a compensation grayscale value. If the brightness information is the brightness value or the compensation grayscale value, the brightness value is further converted into a data voltage.

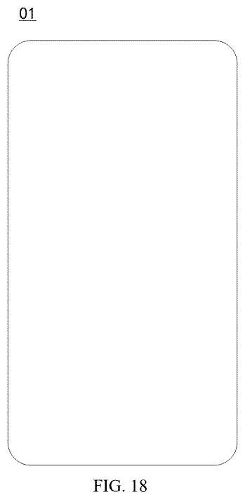

FIG. 18 is a schematic diagram of a display panel according to an embodiment of the present disclosure.

As shown in FIG. 18, an embodiment of the present disclosure further provides a display panel 01, which performs display using the driving method according to any one of the above embodiments. The display panel 01 according to the embodiments of the present disclosure may be a liquid crystal display panel (LCD), an organic light-emitting display panel (OLED), a micro light-emitting diode (Micro-LED) display panel, a mini light-emitting diode (Mini-LED) display panel, or the like.

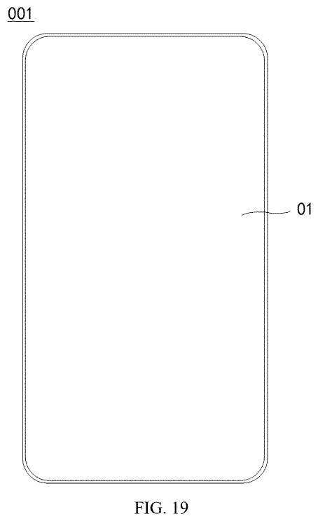

FIG. 19 is a schematic diagram of a display device according to an embodiment of the present disclosure.

As shown in FIG. 19, an embodiment of the present disclosure further provides a display device 001, including the display panel 01 according to any of the above embodiments. It should be understood that the display device 001 shown in FIG. 19 is merely illustrative, and the display device 001 may be any electronic device having a display function, such as a mobile phone, a tablet computer, a notebook computer, an e-book, a television, and a splicing display device.

The above descriptions are merely preferred embodiments of the present disclosure and are not intended to limit the present disclosure. It should be noted that any modifications, equivalent substitutions, improvements, and the like made within the spirit and principle of the present disclosure shall fall within the scope of the present disclosure.

What is claimed is:

1. A brightness compensation method for determining a brightness compensation function of a display panel, comprising:
determining a first grayscale interval for a first Gamma value, wherein the first grayscale interval comprises at least three anchor grayscales and a plurality of non-anchor grayscales;
acquiring a first initial nonlinear function corresponding to the first grayscale interval based on the first grayscale interval; and
correcting the first initial nonlinear function corresponding to the first grayscale interval based on preset brightness information and theoretical brightness information corresponding to the at least three anchor grayscales in the first grayscale interval, so that preset brightness information corresponding to a same anchor grayscale in the first grayscale interval matches theoretical brightness information, wherein theoretical brightness information is brightness information corresponding to an anchor grayscale obtained based on a nonlinear function.

2. The method according to claim 1, further comprising:
determining a second grayscale interval for the first Gamma value, wherein the second grayscale interval comprises at least three anchor grayscales and a plurality of non-anchor grayscales, and the second grayscale interval is different from the first grayscale interval;
acquiring a second initial nonlinear function corresponding to the second grayscale interval based on the second grayscale interval; and
correcting the second initial nonlinear function corresponding to the second grayscale interval based on preset brightness information and theoretical brightness information corresponding to the at least three anchor grayscales in the second grayscale interval, so that preset brightness information corresponding to a same anchor grayscale in the second grayscale interval matches the theoretical brightness information.

3. The method according to claim 1, further comprising:
determining a third grayscale interval for the first Gamma value, wherein a Gamma curve corresponding to the first Gamma value comprises a first portion within the first grayscale interval and a second portion within the third grayscale interval, and a slope change rate of the first portion is greater than a slope change rate of the second portion; and
determining a first-type linear function corresponding to the third grayscale interval based on anchor grayscales in the third grayscale interval and brightness information corresponding to the anchor grayscales in the third grayscale interval, wherein the first-type linear function is a function for determining brightness information corresponding to non-anchor grayscales in the third grayscale interval based on the non-anchor grayscales in the third grayscale interval.

4. The method according to claim 1, wherein the first grayscale interval comprises a first-type non-anchor grayscale and a second-type non-anchor grayscale, and the second-type non-anchor grayscale is between the first-type non-anchor grayscale and one of the at least three anchor grayscales,
wherein the nonlinear function is a function for determining brightness information corresponding to the first-type non-anchor grayscale based on the first-type non-anchor grayscale, and
wherein the method further comprises:
determining a second-type linear function corresponding to the first grayscale interval based on the at least three anchor grayscales in the first grayscale interval and brightness information corresponding to the at least three anchor grayscales in the first grayscale interval, wherein the second-type linear function is a function for determining brightness information corresponding to the second-type non-anchor grayscale based on the second-type non-anchor grayscale.

5. The method according to claim 4, wherein said determining a second-type linear function corresponding to the first grayscale interval based on the at least three anchor grayscales in the first grayscale interval and brightness information corresponding to the at least three anchor grayscales in the first grayscale interval comprises:
determining the second-type linear function corresponding to any adjacent anchor grayscales in the first grayscale interval based on the adjacent anchor grayscales in the first grayscale interval and brightness information respectively corresponding to the adjacent anchor grayscales in the first grayscale interval.

6. The method according to claim 1, wherein the preset brightness information is a preset data voltage value, and the theoretical brightness information is a theoretical data voltage value, and
wherein said correcting the first initial nonlinear function corresponding to the first grayscale interval based on preset brightness information and theoretical brightness information corresponding to the at least three anchor grayscales in the first grayscale interval, so that the preset brightness information corresponding to a same anchor grayscale in the first grayscale interval matches the theoretical brightness information comprises:
calling preset data voltages corresponding to the at least three anchor grayscales in the first grayscale interval; and
correcting the first initial nonlinear function corresponding to the first grayscale interval based on the preset data voltages and theoretical data voltages corresponding to the at least three anchor grayscales in the first grayscale interval, so that a preset data voltage value corresponding to the same anchor grayscale in the first grayscale interval matches a theoretical data voltage value.

7. The method according to claim 1, wherein the preset brightness information is a preset brightness value, and the theoretical brightness information is a theoretical brightness value, and
wherein said correcting the first initial nonlinear function corresponding to the first grayscale interval based on preset brightness information and theoretical brightness information corresponding to the at least three anchor grayscales in the first grayscale interval, so that the preset brightness information corresponding to a same anchor grayscale in the first grayscale interval matches the theoretical brightness information comprises:
collecting preset brightness values of the display panel when displaying the at least three anchor grayscales in the first grayscale interval;
obtaining theoretical data voltages corresponding to the at least three anchor grayscales in the first grayscale interval based on the first initial nonlinear function corresponding to the first grayscale interval;
determining theoretical brightness values corresponding to the at least three anchor grayscales in the first grayscale interval based on the theoretical data voltages corresponding to the at least three anchor grayscales in the first grayscale interval; and
correcting the first initial nonlinear function corresponding to the first grayscale interval based on the preset brightness values and the theoretical brightness values, so that a preset brightness value corresponding to the same anchor grayscale in the first grayscale interval matches a theoretical brightness value.

8. The method according to claim 1, wherein said correcting the first initial nonlinear function corresponding to the first grayscale interval comprises:
correcting an exponent and/or a multiplier of the first initial nonlinear function.

9. The method according to claim 1, further comprising:
determining a fourth grayscale interval for a second Gamma value, wherein the fourth grayscale interval comprises at least three anchor grayscales and a plurality of non-anchor grayscales, and the fourth grayscale interval determined for the second Gamma value is different from the first grayscale interval determined for the first Gamma value;
acquiring a third initial nonlinear function corresponding to the fourth grayscale interval based on the fourth grayscale interval, wherein the third initial nonlinear function acquired for the second Gamma value is different from the first initial nonlinear function acquired for the first Gamma value; and
correcting the third nonlinear function corresponding to the fourth grayscale interval based on preset brightness information and theoretical brightness information corresponding to the at least three anchor grayscales in the fourth grayscale interval, so that the preset brightness information corresponding to a same anchor grayscale in the fourth grayscale interval matches the theoretical brightness information.

10. The method according to claim 1, further comprising:
determining a plurality of target intervals corresponding to the first grayscale interval based on a plurality of anchor grayscales in the first grayscale interval, wherein a first target interval of the plurality of target intervals comprises at least three anchor grayscales, a target anchor grayscale in the first target interval is one of the at least three anchor grayscales in the first grayscale interval, and the target anchor grayscale in the first target interval is between other anchor grayscales in the first target interval;
determining theoretical brightness information of non-anchor grayscales in the first target interval based on a nonlinear function corresponding to the non-anchor grayscales in the first target interval; and
obtaining theoretical brightness information of the target anchor grayscale in the first target interval based on the theoretical brightness information of the non-anchor grayscales in the first target interval.

11. The method according to claim 10, wherein a grayscale value of the target anchor grayscale is an intermediate value among grayscale values of the at least three anchor grayscales in the first target interval of the target anchor grayscale.

12. The method according to claim 10, wherein said obtaining theoretical brightness information of the target anchor grayscale in the first target interval based on the theoretical brightness information of the non-anchor grayscales in the first target interval comprises:
performing a weighted summation on the theoretical brightness information of the non-anchor grayscales in the first target interval to obtain the theoretical brightness information of the target anchor grayscale, wherein a weight for weighting theoretical brightness information corresponding to a first non-anchor grayscale of the non-anchor grayscales in the first target interval is related to a difference between a grayscale value of the first non-anchor grayscale and a grayscale value of the target anchor grayscale.

13. The method according to claim 12, wherein the weight ω(s) for weighting the theoretical brightness information corresponding to the first non-anchor grayscale satisfies:
$$ω ( s ) \{ \begin{matrix}\begin{matrix}4 {s}^{3} - 4 {s}^{2} + \frac{2}{3} , & 0 \leq s \leq 0.5\end{matrix} \\ \begin{matrix}\frac{4}{3} {( 1 - s )}^{3} , & 0.5 < s \leq 1\end{matrix} \\ \begin{matrix}0 , & s > 1\end{matrix}\end{matrix} ,$$
wherein s=d/D, D is a difference between an upper boundary and a lower boundary of the first target interval, and d is an absolute value of the difference between the grayscale value of the first non-anchor grayscale and the grayscale value of the target anchor grayscale.

14. A driving method for a display panel, comprising:
calling a first nonlinear function corresponding to a first grayscale interval based on a first non-anchor grayscale belonging to the first grayscale interval, wherein the first nonlinear function corresponding to the first grayscale interval is a corrected nonlinear function obtained by a brightness compensation method; and
acquiring a data voltage corresponding to the first non-anchor grayscale based on the first nonlinear function corresponding to the first grayscale interval,
wherein the brightness compensation method comprises:
determining the first grayscale interval for a first Gamma value, wherein the first grayscale interval comprises at least three anchor grayscales and a plurality of non-anchor grayscales;
acquiring a first initial nonlinear function corresponding to the first grayscale interval based on the first grayscale interval; and
correcting the first initial nonlinear function corresponding to the first grayscale interval based on preset brightness information and theoretical brightness information corresponding to the at least three anchor grayscales in the first grayscale interval, so that the preset brightness information corresponding to a same anchor grayscale in the first grayscale interval matches the theoretical brightness information, wherein theoretical brightness information is brightness information corresponding to an anchor grayscale obtained based on a nonlinear function.

15. The driving method according to claim 14, comprising:
calling a second nonlinear function corresponding to a second grayscale interval based on a second non-anchor grayscale belonging to the second grayscale interval, wherein the second nonlinear function corresponding to the second grayscale interval is a corrected nonlinear function obtained by the brightness compensation method; and
acquiring a data voltage corresponding to the second non-anchor grayscale based on the second nonlinear function corresponding to the second grayscale interval,
wherein the brightness compensation method further comprises:
determining the second grayscale interval for the first Gamma value, wherein the second grayscale interval comprises at least three anchor grayscales and a plurality of non-anchor grayscales, and the second grayscale interval is different from the first grayscale interval;
acquiring a second initial nonlinear function corresponding to the second grayscale interval based on the second grayscale interval; and
correcting the second initial nonlinear function corresponding to the second grayscale interval based on preset brightness information and theoretical brightness information corresponding to the at least three anchor grayscales in the second grayscale interval, so that the preset brightness information corresponding to a same anchor grayscale in the second grayscale interval matches the theoretical brightness information.

16. The driving method according to claim 14, comprising:
calling a first-type linear function corresponding to a third grayscale interval based on a third non-anchor grayscale belonging to the third grayscale interval, wherein the first-type linear function corresponding to the third grayscale interval is a linear function obtained by the brightness compensation method; and
acquiring a data voltage corresponding to the third non-anchor grayscale based on the first-type linear function corresponding to the third grayscale interval,
wherein the brightness compensation method further comprises:
determining the third grayscale interval for the first Gamma value, wherein a Gamma curve corresponding to the first Gamma value comprises a first portion within the first grayscale interval and a second portion within the third grayscale interval, and a slope change rate of the first portion is greater than a slope change rate of the second portion; and
determining a first-type linear function corresponding to the third grayscale interval based on anchor grayscales in the third grayscale interval and brightness information corresponding to the anchor grayscales in the third grayscale interval, wherein the first-type linear function is a function for determining brightness information corresponding to non-anchor grayscales in the third grayscale interval based on the non-anchor grayscales in the third grayscale interval.

17. The driving method according to claim 14, wherein the first grayscale interval comprises a first-type non-anchor grayscale and a second-type non-anchor grayscale, the second-type non-anchor grayscale is between the first-type non-anchor grayscale and one of the at least three anchor grayscales in the first grayscale interval, and the first nonlinear function is a function for determining brightness information corresponding to the first-type non-anchor grayscale based on the first-type non-anchor grayscale,
wherein said calling a first nonlinear function corresponding to a first grayscale interval based on a first non-anchor grayscale belonging to the first grayscale interval comprises:
calling the first nonlinear function corresponding to the first grayscale interval based on the first-type non-anchor grayscale belonging to the first grayscale interval; and
calling a second-type linear function corresponding to the first grayscale interval based on the second-type non-anchor grayscale belonging to the first grayscale interval, wherein the second-type linear function corresponding to the first grayscale interval is a linear function obtained by the brightness compensation method, and
wherein said acquiring a data voltage corresponding to the first non-anchor grayscale based on the first nonlinear function corresponding to the first grayscale interval comprises:
acquiring a data voltage corresponding to the first-type non-anchor grayscale based on the first nonlinear function corresponding to the first grayscale interval; and
acquiring a data voltage corresponding to the second-type non-anchor grayscale based on the second-type linear function corresponding to the first grayscale interval,
wherein the brightness compensation method further comprises:
determining the second-type linear function corresponding to the first grayscale interval based on the at least three anchor grayscales in the first grayscale interval and brightness information corresponding to the at least three anchor grayscales in the first grayscale interval, wherein the second-type linear function is a function for determining brightness information corresponding to the second-type non-anchor grayscale based on the second-type non-anchor grayscale.

18. A display device, comprising a display panel, wherein the display panel is configured to be driven for display using a driving method, wherein the driving method comprises:
calling a first nonlinear function corresponding to a first grayscale interval based on a first non-anchor grayscale belonging to the first grayscale interval, wherein the first nonlinear function corresponding to the first grayscale interval is a corrected nonlinear function obtained by a brightness compensation method; and
acquiring a data voltage corresponding to the first non-anchor grayscale based on the first nonlinear function corresponding to the first grayscale interval,
wherein the brightness compensation method comprises:
determining the first grayscale interval for a first Gamma value, wherein the first grayscale interval comprises at least three anchor grayscales and a plurality of non-anchor grayscales;
acquiring a first initial nonlinear function corresponding to the first grayscale interval based on the first grayscale interval; and
correcting the first initial nonlinear function corresponding to the first grayscale interval based on preset brightness information and theoretical brightness information corresponding to the at least three anchor grayscales in the first grayscale interval, so that the preset brightness information corresponding to a same anchor grayscale in the first grayscale interval matches the theoretical brightness information, wherein theoretical brightness information is brightness information corresponding to an anchor grayscale obtained based on a nonlinear function.
